(19) United States
(12) Patent Application Publication
(10) Pub. No.: US 2011/0058213 A1
(43) Pub. Date: Mar. 10, 2011

(54) Print Job Report Customization Mechanism

(76) Inventors: Marquis G. Waller, Beverly, OH (US); Kyle P. Manning, Lafayette, CO (US); Linda Sue Liebelt, Boulder, CO (US)

(21) Appl. No.: 12/556,742

(22) Filed: Sep. 10, 2009

(51) Int. Cl. G06F 15/00

(52) U.S. Cl. 358/1.15

(57) ABSTRACT

A method disclosed. The method includes a user selecting one or more attributes to be included in a print report, allocating locations for each of the selected attributes in the print report, receiving a stream of print data, collecting data from the data stream associated with each of the selected attributes and generating the print report by inserting the collected data into each of the allocated locations.

### FIELD OF THE INVENTION

The invention relates to the field of computer systems, and in particular, to upgrading printing software products.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is implemented at a print server to manage a print job from job entry and management through the complete printing process. The printing software often includes a reporting feature that generates reports for tracking various print statistics. However, reporting tools implemented in most printing software products track and display data based on attributes defined at installation. Thus, a user is prevented from customizing the data that is tracked and collected in a report.

Accordingly, a mechanism to customize data collected in a report is desired.

### SUMMARY

In one embodiment, a method includes a user selecting one or more attributes to be included in a print report, allocating locations for each of the selected attributes in the print report, receiving a stream of print data, collecting data from the data stream associated with each of the selected attributes and generating the print report by inserting the collected data into each of the allocated locations.

Another embodiment discloses a print server including a printing software product having a graphical user interface (GUI) to enable a user to select one or more attributes to be included in a print report, a script to receive the selected attributes and allocate locations for each of the selected attributes in the print report, listeners to collect data associated with each of the selected attributes from a stream of received print data and a report generator to generate a print report by inserting the collected data into each of the allocated locations.

A further embodiment discloses an article of manufacture comprising a machine-readable medium including data that, when accessed by a machine, cause the machine to perform operations including selecting one or more attributes to be included in a print report, allocating locations for each of the selected attributes in the print report, receiving a stream of print data, collecting data from the data stream associated with each of the selected attributes and generating the print report by inserting the collected data into each of the allocated locations.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrate screen shots of embodiments of a reporting component of a graphical user interface;

FIG. 3 illustrates one embodiment of a printing software product; and

FIG. 4 illustrates one embodiment of a computer system.

### DETAILED DESCRIPTION

A print job report generation mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

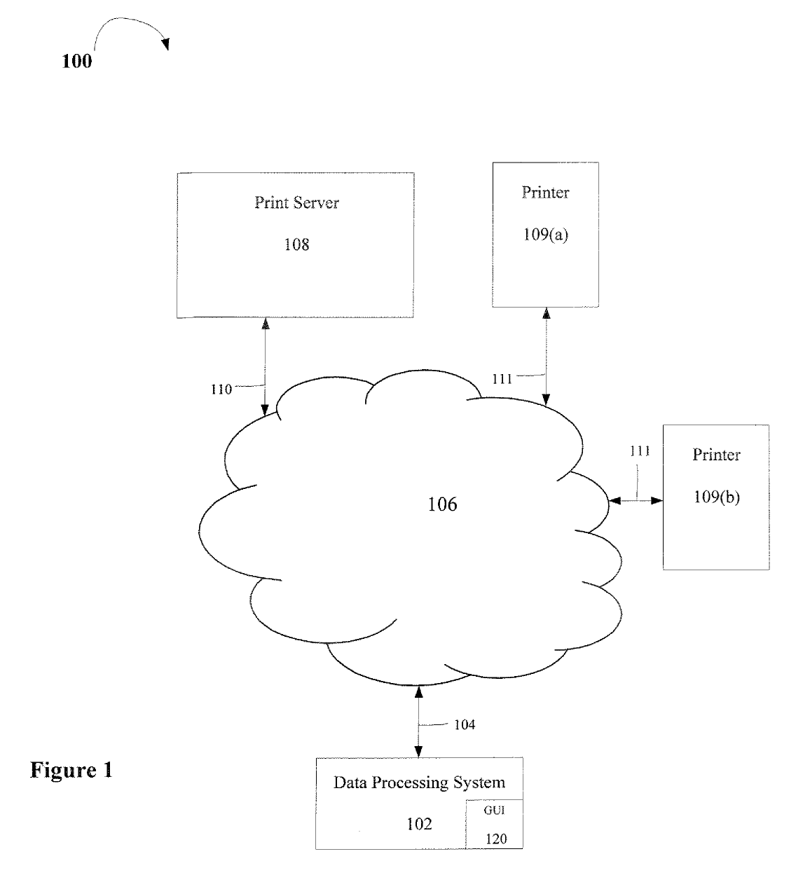

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, the operating system on data processing system 102 allows a user to select the desired print server 108 and submit requests for service requests to printer 109 via print server 108 over network 106. In a further embodiment, print server 108 includes a print queue for print jobs requested by remote data processing systems.

Although described as separate entities, other embodiments may include print server 108 being incorporated in one or more of the printers 109. However in other embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 between data processing system 102 and one or more of printers 109. In other embodiments, the printing software manages printing of documents from multiple data processing systems 102 to the one or more printers 109.

According to one embodiment, the printing software product may be implemented using either InfoPrint Manager (IPM) or InfoPrint ProcessDirector (IPPD), although other types of printing software may be used instead. In a further embodiment, data processing system 102 includes a print application that interacts with the printing software product at printer server 108 to provide for efficient transmission of print jobs.

In one embodiment, the printing software product includes a graphical user interface (GUI) 120 that enables a system administrator (or operator) to interact with the print application. In a further embodiment, an operator at data processing system 102 implements GUI 120 to automatically submit print jobs to the printing software product at printer server 108.

In still a further embodiment, GUI 120 includes a report generator that enables a user to specify data that is to be collected from the printing software product and stored for reports. In such an embodiment, the printing software product includes attributes that may be collected and displayed. Attributes in the printing software product are used to monitor print job progress (e.g., Job status, job printing time, etc. . . . ), as well as information about the Job (e.g., form, customer name, destination, etc. . . . ). According to one embodiment, a default set of attributes may be included for report generation. These attributes may be preset by the printing software product manufacturer, or set up by a user during initial installation and configuration of the printing software product.

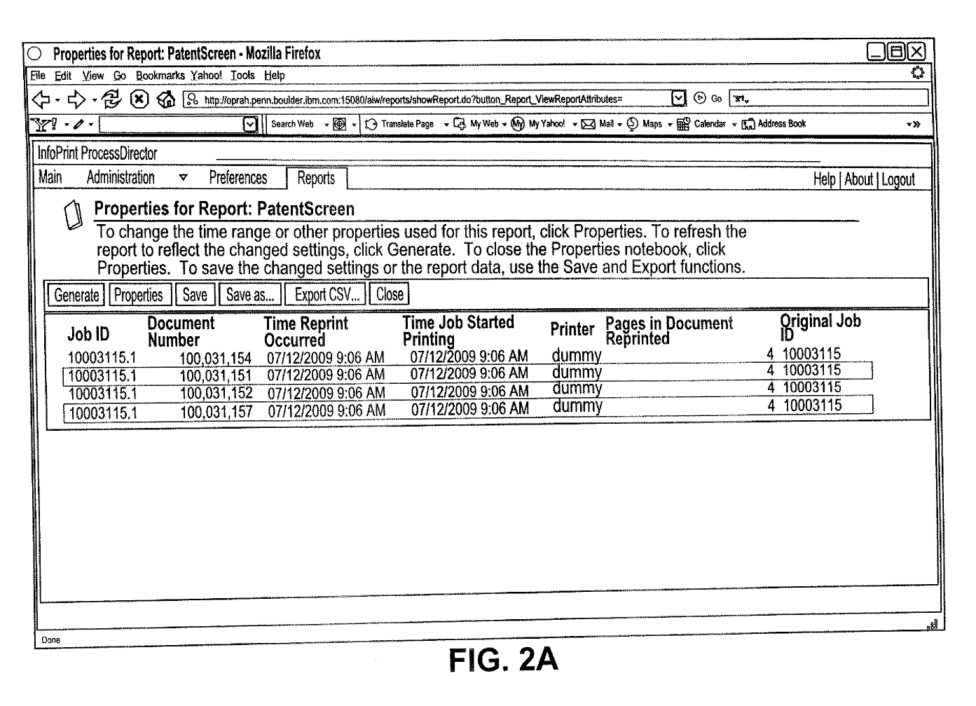

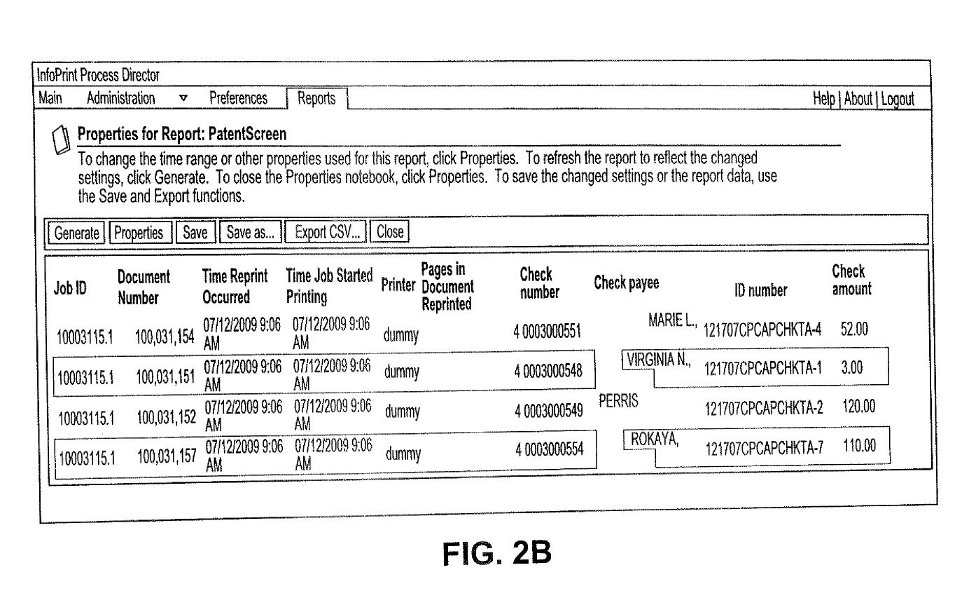

FIG. 2A is a screen shot illustrating one embodiment of a report page of GUI 120. Basic attributes collected and displayed in FIG. 2A include print job ID, document number, time reprint occurred, etc. In one embodiment, GUI 120 provides a user the ability to customize a report to track additional attributes, or actually change the attributes that are tracked, as the user's business changes. In such an embodiment, the attributes collected and reported may be modified without requiring a restart to the printing software product. Thus, the user does not have to interrupt production to modify the reports and collection.

In one embodiment, the printing software product provides a configuration file that allows a user to specify a type of report for which the user would like to add or change attributes. In this embodiment, the user fills out the configuration file by specifying the name of the attribute in the printing software product. Table 1 shows an exemplary configuration file.

TABLE 1
# Licensed Materials - Property of InfoPrint Solutions Company.
#
# Package: com.ibm.aiw (reprint_doc.cfg)
#
# Copyright InfoPrint Solutions Company 2009. All rights reserved.
#
# NOTE: This program sample is provided on an as-is basis.
# The licensee of the product is free to copy, revise, modify, and make
# derivative works of this program sample as they see fit.
# =====================================================
#Doc.Insert.Status=Document Insert Status
Doc.Custom.number=Check number − Added by customer
Doc.Custom.checkpayee=Check payee − Added by customer
Doc.Custom.ID=ID number − Added by customer
Doc.Custom.amount=Check amount − Added by customer

As shown in Table 1, a user specifies in the configuration file for add check number, check payee, ID number and check amount attributes to be included in a report. However in another embodiment, GUI 120 includes a list of attributes in which a user has the ability to select attributes that are to be included in a report by selecting a box next to an attribute.

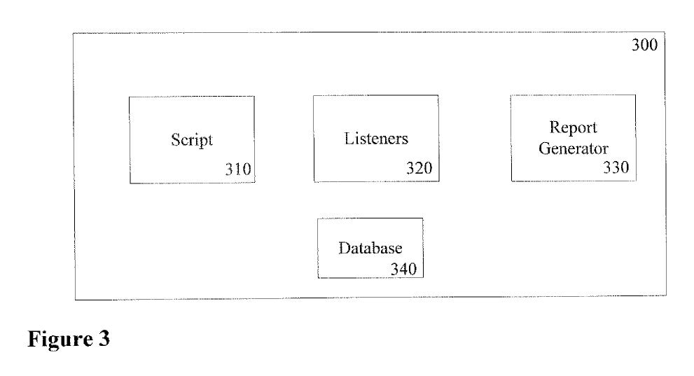

FIG. 3 illustrates one embodiment of components of a printing software product 300 that provide for customized reports. Printing software product 300 includes script 310, listeners 320, report generator 330 and database 340. Script 310 receives the list of attributes and allocates locations for the selected attributes in the report. For instance, script 310 may create new rows in the proper tables in database 340. However, if the attribute is already included (e.g., an old attribute that is being added back or one already existing) no new row is created. Instead, an old row is used and any data previously tracked can be viewed again.

Script 310 also notifies listeners 320 to begin listening and requesting information about these attributes. According to one embodiment, listeners 320 read properties within Advanced Function Presentation (AFP) data streams received at print server 108 in order to collect data on the attributes specified to be included in the customized report.

Report generator 330 generates the customized reports. In one embodiment, the reports view is updated so that the new attributes will be present in the report the next time the report is displayed. FIG. 2B is a screen shot illustrating one embodiment of a report page after the new attributes have been included. As shown in FIG. 2B, the report includes data corresponding to the user added attributes. In one embodiment, a Reports Property feature is included to enable users to group and filter added/new attributes by updating group and filter choices for the report type.

In one embodiment, printing software product 300 does not clear out data that is removed from collection. An example is that a user configures a report that tracks Doc.Check_Number. A few weeks later the user changes the report to track on Doc.Account_Number and Doc.Name and removes tracking on Doc.Check_Number. If after working with the new report the user realizes that Doc.Check_Number is needed, the user can add it back and all of the previous data will still be there.

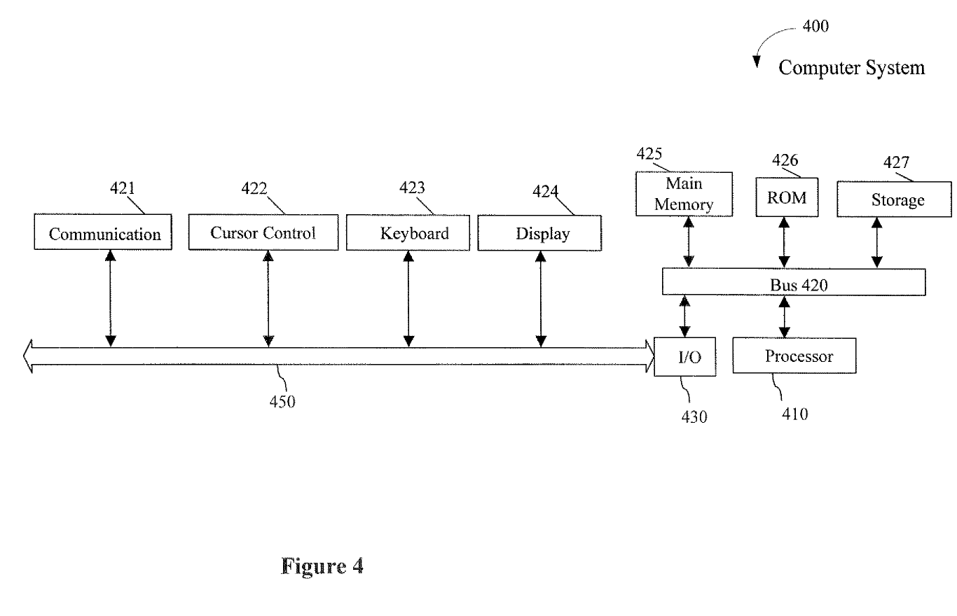

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

The above-described mechanism enables users to dynamically specify data that is to be collected from a printing software product and stored for customizing reports.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
receiving one or more user selected attributes to be included in a print report;
allocating locations for each of the selected attributes in the print report;
receiving a stream of print data;
collecting data from the data stream associated with each of the selected attributes; and
generating the print report by inserting the collected data into each of the allocated locations.

2. The method of claim 1 wherein selecting the one or more attributes comprises changing existing attributes.

3. The method of claim 1 wherein selecting the one or more attributes comprises selecting one or more additional attributes.

4. The method of claim 1 wherein selecting the one or more attributes comprises generating a configuration file.

5. The method of claim 4 wherein generating the configuration file comprises specifying attributes to be included in the print report.

6. The method of claim 1 wherein selecting the one or more attributes comprises selecting each attribute in a graphical user interface (GUI).

7. The method of claim 1 wherein allocating locations for the selected attributes comprises adding a new row in the print report for each selected attribute.

8. The method of claim 1 wherein the data stream is an Advanced Function Presentation (AFP) data stream.

9. A print server, comprising:
a printing software product having:
a graphical user interface (GUI) to enable a user to select one or more attributes to be included in a print report;
a script to receive the selected attributes and allocate locations for each of the selected attributes in the print report;
listeners to collect data associated with each of the selected attributes from a stream of received print data; and
a report generator to generate a print report by inserting the collected data into each of the allocated locations.

10. The print server of claim 9 wherein selecting the one or more attributes comprises changing existing attributes.

11. The print server of claim 9 wherein selecting the one or more attributes comprises selecting one or more additional attributes.

12. The print server of claim 11 wherein selecting the one or more attributes additional attributes is performed without having to restart the printing software product.

13. The print server of claim 1 wherein selecting the one or more attributes comprises generating a configuration file.

14. The print server of claim 9 wherein selecting the one or more attributes comprises selecting each attribute in the GUI.

15. The print server of claim 9 wherein the script allocates locations for the selected attributes by adding a new row in the print report for each selected attribute.

16. The print server of claim 9 wherein the data stream is an Advanced Function Presentation (AFP) data stream.

17. An article of manufacture comprising a machine-readable medium including data that, when accessed by a machine, cause the machine to perform operations comprising:
receiving one or more user selected attributes to be included in a print report;
allocating locations for each of the selected attributes in the print report;
receiving a stream of print data;
collecting data from the data stream associated with each of the selected attributes; and
generating the print report by inserting the collected data into each of the allocated locations.

18. The article of manufacture of claim 17 wherein selecting the one or more attributes comprises generating a configuration file.

19. The article of manufacture of claim 18 wherein generating the configuration file comprises specifying attributes to be included in the print report.

20. The article of manufacture of claim 17 wherein selecting the one or more attributes comprises selecting each attribute in a graphical user interface (GUI).

21. The article of manufacture of claim 17 wherein allocating locations for the selected attributes comprises adding a new row in the print report for each selected attribute.
